(19) United States
(12) Patent Application Publication
(10) Pub. No.: US 2013/0209039 A1
(43) Pub. Date: Aug. 15, 2013

(54) OPTICAL FIBER CONNECTOR ASSEMBLY

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/525,379

(22) Filed: Jun. 18, 2012

(30) Foreign Application Priority Data
Feb. 15, 2012 (TW) 101104858

(51) Int. Cl. G02B 6/36

(52) U.S. Cl. 385/77

(57) ABSTRACT

An optical fiber connector assembly includes a plug and a socket coupled with the plug. The structure of the socket is the same as the structure of the plug. The plug includes a first positioning pole and a first positioning hole, and the socket includes a second positioning pole and a second positioning hole. The first positioning pole of the plug is received in the second positioning hole of the socket, and the second positioning pole of the socket is received in the first positioning hole.

### BACKGROUND

1. Technical Field

The present disclosure relates to optics and, particularly, to an optical fiber connector assembly.

2. Description of Related Art

Optical fiber connector assemblies include a plug (i.e., male connector) and a socket (i.e., female connector). The plug and the socket are typically formed by molding. However, the structure of the plug is different from that of the socket, and thus two different molds are needed, which increases the cost of the optical fiber connector assembly.

Therefore, it is desirable to provide an optical fiber connector assembly, which can overcome the limitations described.

### BRIEF DESCRIPTION OF THE DRAWINGS

FIG. 1 is an assembled view of an optical fiber connector assembly in accordance with an exemplary embodiment.

FIG. 2 is a cross-sectional view taken along a line II-II of FIG. 1.

FIG. 3 is an assembled view of a plug of the optical fiber connector assembly of FIG. 1.

FIG. 4 is an assembled view of a socket of the optical fiber connector assembly of FIG. 1.

### DETAILED DESCRIPTION

Embodiments of the disclosure will be described with reference to the drawings.

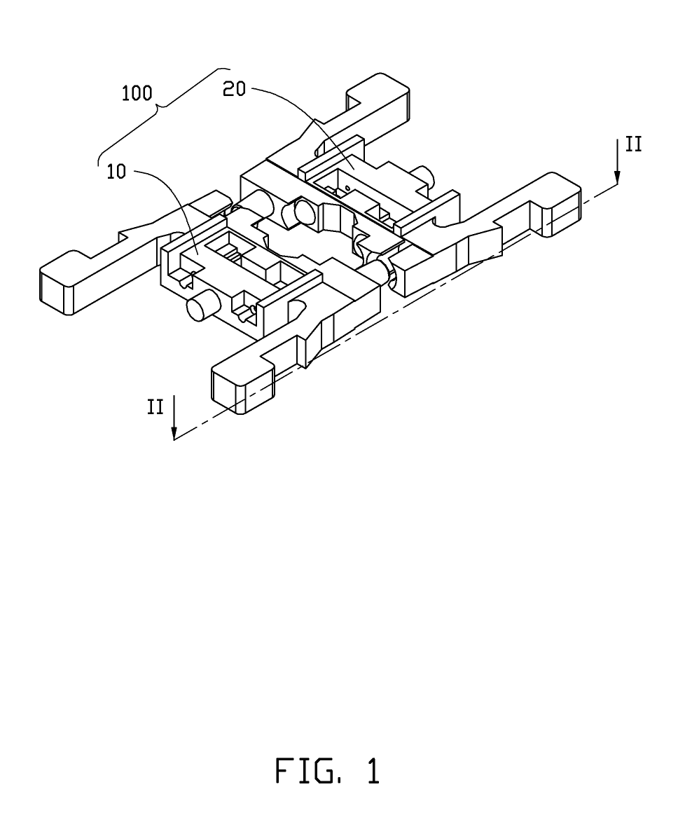

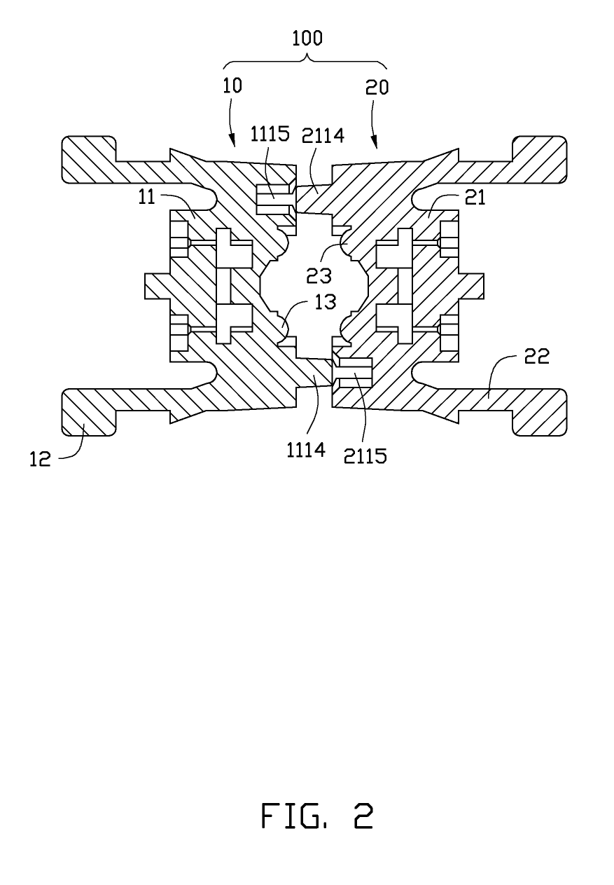

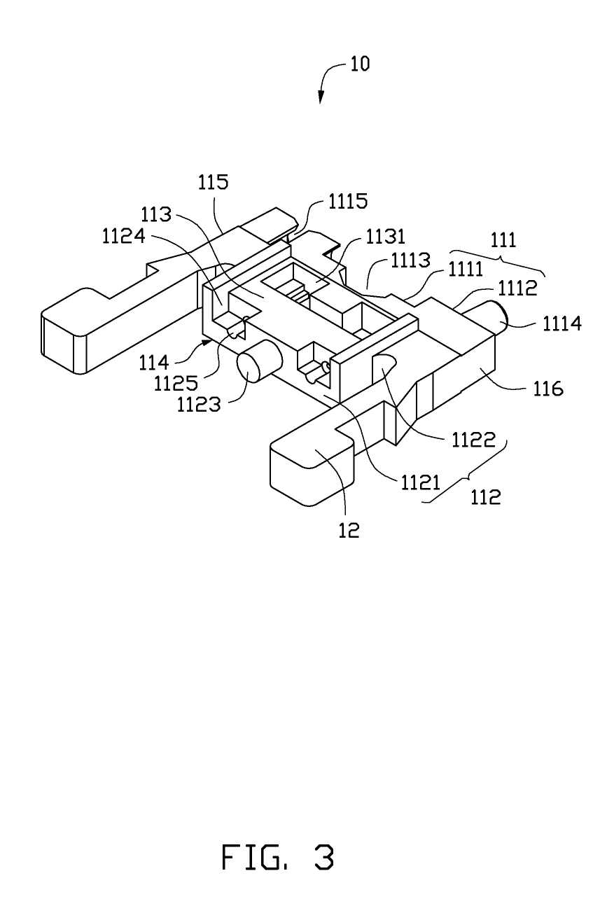

Referring to FIGS. 1-3, an optical fiber connector assembly 100, according to an exemplary embodiment, includes a plug 10 and a socket 20 coupled with the plug 10. The plug 10 and the socket 20 have a common central axis when coupled.

The plug 10 includes a first main body 11, two first operation portions 12, and two first lenses 13. The first main body 11, the first operation portions 12, and the first lenses 13 are molded in one mold and thus are integrated with each other. The number of the first lenses 13 is not limited to this embodiment and can be changed according to needs.

The first main body 11 is square-shaped and includes a front surface 111, a back surface 112, a top surface 113, a bottom surface 114, a left surface 115, and a right surface 116. The back surface 112 is opposite to the front surface 111. The bottom surface 114 is opposite to the top surface 113. The right surface 116 is opposite to the left surface 115. The top surface 113, the bottom surface 114, the left surface 115, and the right surface 116 are connected between the front surface 111 and the back surface 112. The central axis of the plug 10 is substantially perpendicular to the front surface 111 and the back surface 112.

The front surface 111 includes a first lower surface 1111 and two first upper surfaces 1112. The first lower surface 1111 is positioned between the two first upper surfaces 1112. The two first upper surfaces 1112 are coplanar and protrude from the first main body 11 relative to the first lower surface 1111.

The first main body 11 defines a positioning recess 1113 on the first lower surface 1111, generally at the middle of the first lower surface 1111. The central axis of the positioning recess 1113 is collinear with the central axis of the plug 10. The two first lenses 13 are positioned on the first lower surface 1111, generally positioned at two sides of the positioning recess 1113. The two first lenses 13 are axisymmetric with the central axis of the positioning recess 1113. A first positioning pole 1114 is perpendicularly extended outward from one of the first upper surfaces 1112. The first main body 11 defines a first positioning hole 1115 on the other first upper surface 1112. The shape of the first positioning pole 1114 corresponds to the first positioning hole 1115 for a close fit.

The back surface 112 includes a second upper surface 1121 and two second lower surfaces 1122. The second upper surface 1121 is positioned between the two second lower surfaces 1122. The two second lower surfaces 1122 are coplanar, and the second upper surface 1121 protrudes from the first main body 11 relative to the second lower surfaces 1122.

A first pole 1123 is perpendicularly extended outward from the second upper surface 1121, generally at middle of the second upper surface 1121. The first main body 11 defines two first notches 1124 on the second upper surface 1121, and the first notches 1124 are communicated with the upper surface 113. The first main body 11 defines two first receiving holes 1125 corresponding to the first lenses 13 on the second upper surface 1121. A central axis of the first receiving hole 1125 is aligned with an optical axis of the first lens 13. Each of the first receiving holes 1125 extends from the second upper surface 1121 to the first lower surface 1111. A part of the first receiving hole 1125 is communicated with the first notches 1124. The two first receiving holes 1125 are axisymmetric with the central axis of the first pole 1123, and used for receiving an optical fiber therein. The first operation portions 12 are positioned on the second lower surfaces 1122 and extend along a direction facing away from the front surface 111.

The first main body 11 defines a first recess 1131 on the top surface 113, a part of the first receiving holes 1125 is exposed from the first recess 1131. It is to be understood that the first recess 1131 can alternatively be defined on the bottom surface 114.

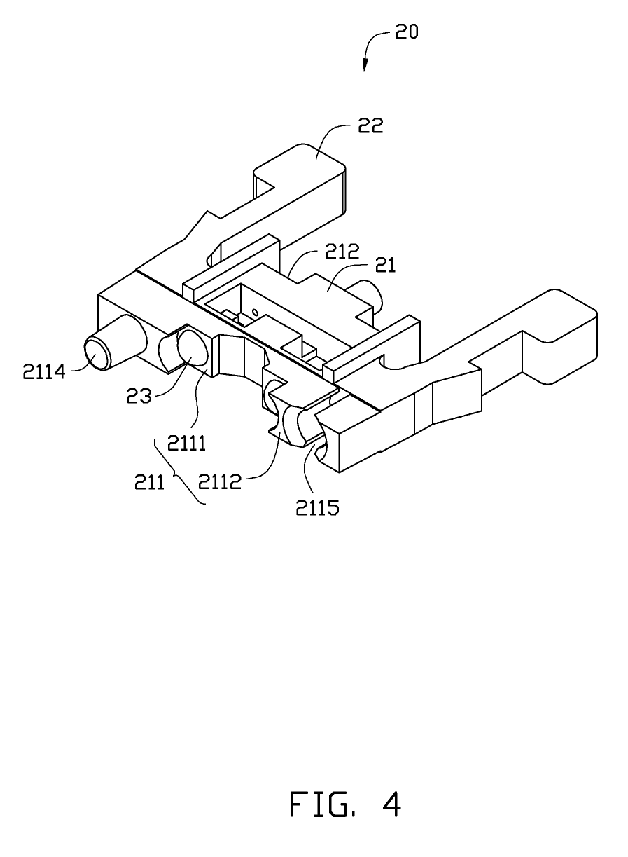

Referring to FIG. 4, the structure of the socket 20 is the same as the structure of the plug 10. The socket 20 includes a second main body 21, two second operation portions 22, and two second lenses 23. The second main body 21, the second operation portions 22, and the second lenses 23 are integrated molded into one body.

The structure of the second main body 21 is the same as the structure of the first main body 11. The second main body 21 includes a front surface 211 and a back surface 212 opposite to the front surface 211. The central axis of the socket 20 is perpendicular to the front surface 211 and the back surface 212.

The front surface 211 includes a first lower surface 2111 and two first upper surfaces 2112. The first lower surface 2111 is positioned between the two first upper surfaces 2112. A second positioning pole 2114 is perpendicularly extended outward from one of the first upper surfaces 2112. The second main body 21 defines a second positioning hole 2115 on the other first upper surface 2112.

During the process of coupling the optical fiber connector assembly 100, the first positioning pole 1114 of the plug 10 is received in the second positioning hole 2115 of the socket 20, and the second positioning pole 2114 of the socket 20 is received in the first positioning hole 1115. The first lens 13 is coaxial with the second lens 23. Optical signals travel from the first lenses 13 to the second lenses 23.

As the structure of the socket 20 is the same as the structure of the plug 10, the plug 10 and the socket 20 can be molded by one mold. Therefore, the cost of the optical fiber connector assembly 100 can be decreased.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical fiber connector assembly, comprising:
a plug comprising:
a first main body comprising a front surface and a back surface opposite to the front surface; the front surface comprising a first lower surface and two first upper surfaces positioned at two sides of the first lower surface, the first main body comprising a first positioning pole extending outward from one of the first upper surfaces, the first main body defining a first positioning hole on the other first upper surface; and
a first lens positioned on the first lower surface; and
a socket having the same structure with the plug, the socket comprising:
a second main body comprising a second positioning pole and a second positioning hole; wherein the first positioning pole of the plug is received in the second positioning hole of the socket, and the second positioning pole of the socket is received in the first positioning hole; and
a second lens positioned on the second main body, wherein the first lens and the second lens are coaxial with each other.

2. The optical fiber connector assembly of claim 1, wherein the two first upper surfaces are coplanar and protrude from the first main body relative to the first lower surface.

3. The optical fiber connector assembly of claim 2, wherein the back surface comprises a second upper surface and two second lower surfaces positioned at two sides of the second upper surface.

4. The optical fiber connector assembly of claim 3, wherein the plug further comprises two operation portions respectively positioned on the two second lower surfaces.

5. The optical fiber connector assembly of claim 3, wherein the first main body defines a receiving hole spatially corresponding to the first lens on the second upper surface, the receiving hole extends from the second upper surface to the first lower surface.

6. The optical fiber connector assembly of claim 5, wherein the first main body comprises a top surface and a bottom surface opposite to the top surface, the first main body defines a recess on the top surface, a part of the receiving holes is exposed from the recess.

7. The optical fiber connector assembly of claim 5, wherein the first main body comprises a pole extending outward from a middle of the second upper surface.

8. The optical fiber connector assembly of claim 7, wherein the first main body defines a positioning recess on the first lower surface, the plug comprises another first lens, the two first lenses are positioned at two sides of the positioning recess, the two first lenses are axisymmetric with a central axis of the positioning recess, the first main body defines another receiving hole, the two receiving holes are axisymmetric with a central axis of the pole, the socket comprises another second lens, each of the first lenses is aligned with a respective one of the second lenses.
